(19) United States
(12) Patent Application Publication
(10) Pub. No.: US 2011/0093247 A1
(43) Pub. Date: Apr. 21, 2011

(54) SYSTEM AND METHOD FOR NON-STEADY STATE MODEL FITTING

(75) Inventor: Brett Beauregard, Arlington, MA (US)

(73) Assignee: Control Station, Inc., Tolland, CT (US)

(21) Appl. No.: 12/997,442

(22) PCT Filed: Jun. 15, 2009
(86) PCT No.: PCT/US09/47352

§ 371 Date: Dec. 10, 2010

Related U.S. Application Data
(60) Provisional application No. 61/061,364, filed on Jun. 13, 2008.

(51) Int. Cl. G06F 17/10; G06F 7/60

(52) U.S. Cl. 703/2

(57) ABSTRACT

A method is presented for modeling a process using non-steady state values of a process variable implemented in a control unit. The method includes steps of dynamically testing the process and accumulating data points. The data points provide a testing data set including measured values of a response process variable and a manipulated variable. The method includes assigning a first data point within the testing set, computing a dead time value for the testing set, modeling the process over the testing set to determine model-predicted values for the measured response variable, and computing an average error value between each model-predicted values and the measured response variable values. The method further includes centering the model-predicted values over the measured values, computing an optimal fit of the centered model-predicted values, and iteratively repeating these steps until the model-predicted values converge to the measured response variable values.

### CROSS-REFERENCE TO RELATED APPLICATIONS

This application is entitled to the benefit of and incorporates by reference essential subject matter disclosed in International Patent Application No. PCT/US2009/047352 filed on Jun. 15, 2009 and claims priority benefit under 35 U.S.C. §119(e) of U.S. Provisional Patent Application Ser. No. 61/061,364, filed Jun. 13, 2008. The disclosure of this U.S. patent application is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### FIELD OF THE INVENTION

This invention relates to systems and methods for modeling a process using non-steady state values as initial conditions and a continuous, time-dependent differential equation for improved convergence of a measured value to a reference input.

### BACKGROUND OF THE INVENTION

Generally speaking, it is well known in the area of process control to provide a mathematical description or model of a process of interest to, for example, improve capabilities and/or the effectiveness of controllers that regulate and maintain process variables within a preferred range of values. For example, existing methods and techniques for identifying mathematical equations and coefficients thereof to model processes and process variables typically require that:

1) there is a steady state operating relationship in the process and the process variables prior to the start of testing, and/or

2) the resulting model form is not a continuous time-dependent differential equation.

As can be appreciated, the aforementioned requirements of existing process modeling methods and techniques is less than satisfactory and, often, difficult to achieve. Accordingly, the inventor has discovered that a modeling procedure and technique that does not require an initial steady state process is a significant advantage and can lead to a more accurate mathematical representation of the process of interest.

### SUMMARY OF THE INVENTION

The present invention resides in one aspect in a method of modeling a process using non-steady state values of a process variable implemented in a control unit. The method includes steps of dynamically testing the process and accumulating data points over a predetermined time period. The data points may be stored in a memory device of the control unit and provide a dynamic testing data set including measured values of a response process variable and a manipulated variable. The method also includes assigning a first data point within the dynamic testing data set, computing a dead time value for the dynamic testing data set, and dynamically modeling the process over the dynamic testing data set to determine model-predicted values for the measured response process variable. In one embodiment, beginning at a data point within the dynamic testing data set that is one dead time within the dynamic testing data set, the method includes computing an average error value between each of the dynamic model-predicted values and the measured response process variable values, centering and shifting the dynamic model-predicted values over the measured response process variable values, and computing an optimal fit of the centered and shifted dynamic model-predicted values relative to the measured response process variable values. The method further includes iteratively repeating the dynamic modeling, computing average error, centering and shifting, and computing the optimal fit steps described above until the dynamic model-predicted values converge to the measured response process variable values within a predetermined level of convergence.

In one embodiment, the measured values of the response process variable and the manipulated variable are accumulated by a sensor that senses the values and is operatively coupled to the control unit. In one embodiment, the step of computing the dead time value includes determining a cross-correlation between the manipulated variable values and the measured response process variable values over the dynamic testing data set.

In one embodiment, the step of dynamically modeling includes solving a continuous-in-time form of a first-order-plus-dead-time (FOPDT) self-regulating dynamic model. The FOPDT self-regulating dynamic model expression is solved using a numerical technique and with initial values of a model dead time θp and a model time constant Tp, and estimates of a model process gain Kp determined using a Golden Section search.

In another embodiment, the step of dynamically modeling includes solving a continuous-in-time form of a first-order-plus-dead-time integrating (FOPDT integrating) non-self-regulating dynamic model. The FOPDT integrating non-self-regulating dynamic model expression is solved using a numerical technique and with initial values of the model dead time θp, and estimates of an integrator process gain Kp* determined using a Golden Section search.

In one embodiment, the step of centering and shifting includes adding an average error value to each of the dynamic model-predicted values within the dynamic testing data set.

### BRIEF DESCRIPTION OF THE DRAWINGS

FIG. 1 is a simplified block diagram of a feedback control loop controlling a process under control of a controller, in accordance with one embodiment of the present invention;

FIG. 2A illustrates a measured response process variable at non-steady state prior to testing;

FIG. 2B illustrates a time-based trace of a manipulated variable, in accordance with one embodiment of the present invention;

FIGS. 3A and 3B illustrate that computed dynamic model values may diverge significantly from the measured response process variable values during dynamic testing;

FIGS. 4A and 4B illustrate graphically computation of error along a collection of data points of a dynamic model, in accordance with one embodiment of the present invention; and

FIGS. 5A and 5B illustrate graphically dynamic model predicted values are obtained by centered and shifting predicted data points over measured response process variable values, in accordance with one embodiment of the present invention.

### GENERAL DEFINITIONS

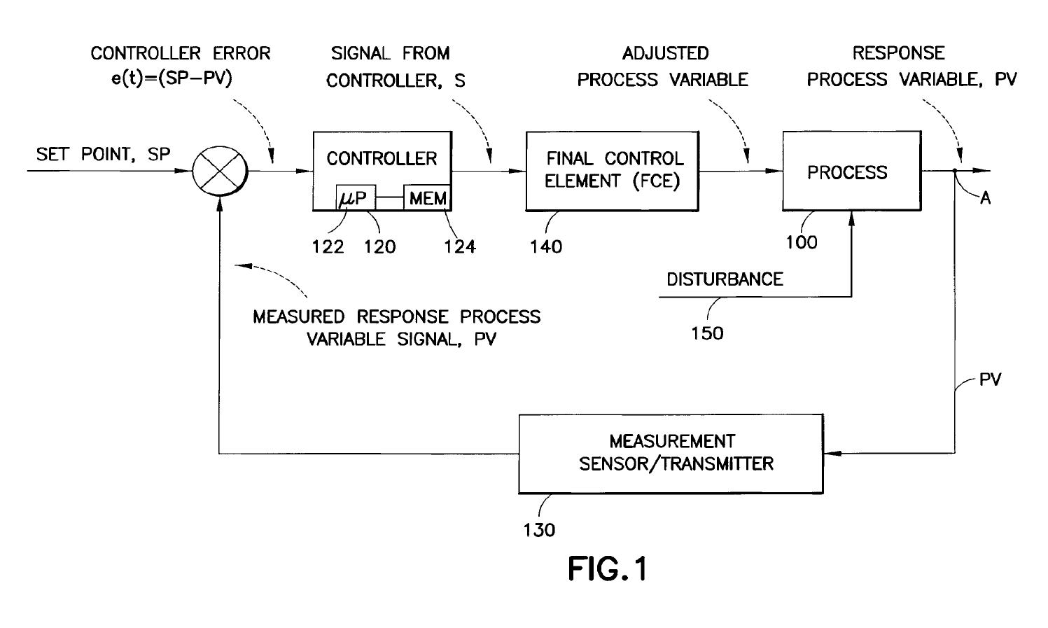

A simplified block diagram of a feedback control loop controlling a process under control of a controller is depicted in FIG. 1. With reference thereto, it should be appreciated that the following definitions are provided to illustrate exemplary embodiments of the present invention and do not limit the scope or interpretation of this disclosure, the appended claims and equivalents thereof that are known to those skilled in the art.

“Controllers” are mathematical algorithms and/or computer programs, implemented as hardware and/or software components operating within a control device such as a PID controller or the like, that is designed to operate a Process and/or a Plant in a controlled and otherwise safe, efficient and profitable fashion. A Controller receives a measured response Process Variable Signal, compares the measurement Signal to a desired set point value, and then computes and transmits controller output Signals to Final Control Elements with the objective of maintaining as closely as desirable, as determined on a case-by-case basis, the measured response Process Variable at the set point value.

“Disturbances” are either anticipated or unanticipated changes that impact and disrupt the Steady State of a response Process Variable and/or Material Stream, and that cause Dynamics. Disturbances may arise from a great many sources including, by way of example but not limitation, from the change of another Process Variable in the Plant; from environmental changes such as humidity, pressure and temperature variations common throughout a day and across seasons; from a Material Stream entering the Plant that has experienced change; from actions of personnel in performing upgrades, maintenance and tests in the Plant; from the degradation or failure of equipment, devices, instruments, appliances and similar items in the Plant; from variations in the utilities supporting a Plant such as the temperature and/or pressure of steam and/or water, from variations in the amperage and/or voltage of electricity, from variations in the heating, ventilation and air conditioning, and from variations in other supporting utilities; and from similar unmeasured and/or unanticipated incidents or disruption that upset the Steady State of a Process Variable. For example, some Disturbances result directly from human action while others do not. Rain is an example of a Disturbance that cannot normally be changed at will by human action. A drop in pressure in a steam line is one of many possible examples of a Disturbance that can occur at will by human action by, for example, adjusting a Final Control Element such as a valve.

“Dynamic” is a time-dependent relationship between any change or movement of a Manipulated Process Variable and/or its Signal and a response Process Variable and/or its measured Process Variable Signal. Process Variables experiencing Dynamics are not at Steady State.

“Dynamic Testing” is a deliberate or fortuitous change, movement or bump of a Manipulated Variable and/or its Signal, and concurrent collection and accumulation of pertinent Signals as the measured response Process Variable reacts over recorded time to that change. While the Manipulated Variable may change in any direction, may alternate direction, and may change randomly and without plan, at least one of the changes must be large enough and occur rapidly enough to cause a measurable and distinct reaction or effect in the responding Process Variable.

“Dynamic Model” is a continuous time-dependent differential equation, complete with specific values for all equation coefficients, that provides a mathematical description of the Dynamic behavior of a Process as revealed by Dynamic Testing. Some of these coefficients do not have predetermined ranges or signs and may assume either positive or negative values. Those coefficients of the equation that have “time” as their sole unit of measure must have values greater than or equal to zero to conform with the forward-moving behavior of the natural world.

“Final Control Element” (FCE) is an instrument, device or apparatus including, by way of example but not limitation, a valve, pump, compressor, heating element, cooling element, blower, fan, vanes, motor, gate, conveyer and all other equipment and appliances that regulate, adjust or manipulate the flow, movement or transport of a Material Stream within, between and among the Processes in a Plant.

“Material Stream” is a gas, liquid, powder, slurry, film, melt, sheet, stock, combinations thereof, or similar matter or state of matter that flows, moves or transports within, between and/or among the Processes in the Plant.

“Manipulated Variable” is a Process Variable and/or a Signal that is changed or moved during Dynamic Testing to produce or cause a change in the measured response Process Variable. Examples of Manipulated Variables include but are not limited to: a signal from a Controller that is transmitted to a Final Control Element; an adjusted Process Variable; the Signal from an adjusted Process Variable; a Disturbance that can be changed at will by human action; and/or the Signal from a Disturbance that can be changed at will by human action.

“Model Fitting” refers to the systematic search and identification of the continuous Dynamic Model coefficients that cause the resultant completed Dynamic Model to portray and describe the observed and/or actual relationship between a Manipulated Variable and a measured response Process Variable.

“Non-Self-Regulating” Processes are those processes where the response Process Variable does not naturally seeks a Steady State operating condition when the Manipulated Variable and major Disturbances are held constant for a sufficient length of time. One illustrative example of a Non-Self-Regulating Process is the liquid level (the response Process Variable) in a vessel (the Process). If the flow rate of liquid exiting the vessel is regulated to a particular value, and if the flow rate of liquid entering the vessel is either larger or smaller than that regulated exit flow rate value, and if there are no other means by which liquid can enter or exit the vessel, then the liquid level will not naturally settle out at a constant Steady State value. Rather, the liquid level within the vessel will either rise (e.g., increase) or fall (e.g., decrease), and continue to do so depending on whether the flow rate of liquid entering is greater than or less than the flow rate of liquid exiting, respectively. The only way the liquid level will remain at a constant value is in the particular circumstance where the flow rate of liquid entering and exiting remain at precisely identical values.

“Optimal Fit” is the use of a mathematically defined objective function, commonly referred to as a performance index, use to define and quantify the goodness-of-fit of a model to data. Two examples of common and widely employed objective functions include minimizing the sum of squared errors (SSE) criterion to as near to zero as is reasonable and/or desirable, and maximizing the square of the correlation coefficient (R2) to as near to one (unity) as is reasonable and/or desirable.

“Plant” is a manufacturing factory, laboratory, business, industry, or private facility where research, development and/or production occurs via a Process or a collection of Processes. By way of example, but in no way a limitation, Plants are found in the chemical, pharmaceutical, cement, brick, coal, consumer products, food, beverage, materials, metals, minerals, mining, oil, gas, paints, coatings, polymer, plastics, power, utilities, pulp, paper, water processing and like industries.

“Process” refers to, but is not limited to, physical operating equipment, machines, devices, apparatus, appliances, instruments, mechanisms, unit operations and other such systems where Material Streams may enter, reside within, and/or exit, and where the conservation and transport of mass, energy, species and momentum, the laws of thermodynamics, and other chemical, thermal and physical laws and relationships govern as one or more properties of the associated Material Streams are altered, impacted or otherwise transformed.

“Process Variables” are physical values and conditions that collectively indicate the state of a Process and/or a Material Stream. By way of example, but in no way to serve as a limitation, Process Variables include: temperature, pressure, density, pH, flow rate, concentration, color, level, amperage, position, tension, resistance, power, conductivity, speed, viscosity, voltage and similar physical values and conditions that collectively indicate the state of a Process and/or a Material Stream at a point in time.

“Self-Regulating” Processes are processes where the response Process Variable naturally seeks a Steady State operating condition when the Manipulated Variables and other major Disturbances are held constant for a sufficient length of time. One of many possible illustrative examples is the temperature (the response Process Variable) within a furnace (the Process). If the flow rate of fuel to the furnace burner (the adjusted Process Variable) is held constant, and if the energy content of the fuel remains constant, and if the surrounding environmental conditions remain constant, and if all other Process Variables of the furnace are constant, then the temperature within the furnace will settle to a constant or Steady State value that may be higher or lower depending on whether the flow rate of fuel to the burner is steady at a higher or lower value.

“Steady State” is a Process condition where the Manipulated Variables and other major Disturbances are not experiencing changes or movements for a period of time, and this condition persists long enough such that the measured response Process Variable has settled and remains constant within some range or band of variation that is considered normal, typical or standard for that particular Process in such a quiescent and undisrupted condition. For example, a Process or Plant that is at Steady State is not experiencing Dynamics.

“Signal” is a useful value of a Process Variable that can be transmitted along and through the Plant computing and communication system and arrives as numerical data suitable for use by a Controller. For example, but in no way serving as a limitation, signal transmissions may communicate values for Manipulated Variables and/or response Process Variables between the actual physical location of a sensor or actuator; or from a data collection or archiving computer; or from another device, apparatus or appliance; and the computer where the Controller is operating.

### DETAILED DESCRIPTION OF PREFERRED EMBODIMENTS

As shown in FIG. 1, a Process 100 is controlled by a Controller 120 such as, for example, a PID controller. The Controller 120 includes a microprocessor (μP) 122 and a memory device (MEM) 124. The Controller 120 receives as input a set point value (SP) that represents a desired value or range of values at which to maintain a response Process Variable (PV). At a predetermined time period, the response Process Variable is sensed or measured at a predetermined point of the Process 100, represented in FIG. 1 as point A, by a measurement device 130 such as, for example, a sensor for sensing pressure, temperature, humidity, amperage or voltage of electricity, and the like. In one embodiment, the measuring device 130 includes, for example, a thermocouple, thermistor, transducer, accelerometer, and the like. The measurement device 130 transmits the measured response Process Variable (PV) to the Controller 120. At the Controller 120, the microprocessor 122 compares the set point value (SP) to the measured response Process Variable (PV) to determine controller error at the predetermined point in time (e(t)), e.g., where e(t)=(SP-PV). The microprocessor 122 evaluates the controller error e(t) and provides a control signal (S) to a Final Control Element (FCE) 140. In effect, the control signal S directs the FCE 140 to adjust or change the response Process Variable (PV). That is, an adjusted Process Variable is introduced to the Process 100 by the FCE 140. As can be appreciated, if the adjusted Process Variable is moved in an appropriate direction and by an appropriate amount, the Process Variable provided in response (e.g., the measured response Process Variable) is maintained near or substantially at the set point value (SP), which is the desired aim or objective of the Controller 120 with respect to the associated Process 100.

As noted above in the Background Section of this disclosure, existing methods and techniques are used to perform Model Fitting of a Dynamic Model to Dynamic Testing data collected from Self Regulating Processes and Non-Self-Regulating Processes. These existing methods require that: (1) there is a Steady State operating relationship between a Manipulated Variable and response Process Variable prior to the start of Dynamic Testing; and/or (2) the Dynamic Model form being fitted is other than a continuous time-dependent differential equation. These requirements are generally recognized as insufficient and a number of alternatives are being explored. For example, one alternative model explored in prior art literature is the discrete-time linear difference relationship model form. The discrete-time linear difference relationship model form is a separate class of equation expressed in an organization of parameters that is not continuous in time.

Moreover, achieving a Steady State operating relationship between a Manipulated Variable and a measured response Process Variable prior to the start of Dynamic Testing on an operating Process can be difficult to achieve. One reason is the highly interdependent nature of Process Variables within and among the Processes in a Plant. As should be appreciated, the Processes in a Plant are interdependent when they are connected by Material Streams. Any Disturbance within or upon a Process can impact a Material Stream and alter one or more Process Variables of that Material Stream. As the affected Material Stream or some portion of the affected Material Stream exits one Process and enters the next Process, this Disturbance impact can move with the Material Stream and impact subsequent Process Variables in a sequence of Processes.

Recycle loops are a design feature in some Plants where a Material Stream or some portion of a Material Stream exits a Process toward the end of a sequence of Processes and is reintroduced at a point toward the beginning of that sequence of Processes. Such a recycle loop heightens the interdependent nature of the Process Variables and the spread or propagation of Disturbances within a Plant.

Disturbances occur to many Processes as frequent yet unpredictable events. By definition, a Disturbance causes Dynamics such that affected Process Variables are not at Steady State. As shown in FIG. 1, to minimize the impact of Disturbances 150, the Controller 120 receives the measured response Process Variables (PV), compares the measured value to the desired set point value (SP), and then computes and transmits the controller output signals (S) to one or more of the Final Control Element (FCE) 140 with the objective of returning and maintaining the measured response Process Variable near or substantially at its designated set point value. The changes from the Controller 120 that is acting to reduce the impact of the Disturbance 150 itself generates different, though intentionally less disruptive, Dynamics that may propagate to, through and among Processes and Material Streams in a Plant.

Thus, the interconnected and interdependent nature of Processes in a Plant results in a situation where the Dynamics of one Process Variable may impact and result in Dynamics to those Process Variables surrounding and physically related to it. If connected by Material Streams, Dynamic behavior may affect other Processes in a sequence, arising in a condition that is not Steady State for many Process Variables.

The combined result of the Controller 120 actions, Manipulated Variable changes, and Disturbances 150 creates an environment where operating Plants are often continually experiencing Dynamic behavior.

One practice when seeking to perform Dynamic Testing is simply to wait for a serendipitous and coincidental time when the behavior of a Process Variable of interest is at Steady State. Waiting for Steady State to occur requires both personnel time and Plant operation time. As can be appreciated, this waiting time represents an economic cost. Another practice intended to facilitate Steady State is to deliberately influence, change or even disable the activity of one or more Controllers. While such action may promote Steady State, it also may decrease the safe operation and economic productivity of the Plant.

In view thereof, the inventor has discovered that it is beneficial to eliminate the requirement for Steady State operation during Dynamic Testing by, for example, providing significantly greater latitude when obtaining acceptable and useful data during Dynamic Testing. As illustrated above, eliminating the requirement for achieving Steady State inherently increases Plant safety and provides significant economic benefits.

### The Dynamic Models

Two example Dynamic Models are described herein. One is the continuous-in-time form of the first-order-plus-dead-time (FOPDT) Self-Regulating Dynamic Model expressed as:

$$Tp \frac{d PV ( t )}{d t} + PV ( t ) = Kp \cdot M ( t - θ p ) \qquad ( 1 )$$

with initial condition of PV(t=t₀) and coupled initial condition of M(t=t₀).

The other is a continuous-in-time form of the first-order-plus-dead-time Integrating (FOPDT Integrating) Non-Self-Regulating Dynamic Model expressed as:

$$\frac{d PV ( t )}{d t} = {Kp}^{*} \cdot M ( t - θ p ) \qquad ( 2 )$$

with initial condition of PV(t=t₀) and coupled initial condition of M(t=t₀).

Where the whole-number numeric values for the coefficients sought through Model Fitting are:
Model Gain, Kp, with units of: PV/M
Integrator Gain, Kp*, with units of: PV/(M·time)
Model Time Constant, Tp, with units of: time
Model Dead Time, θp, with units of: time

And where the independent and dependent variables are defined:
Time, t, with units of: time
Time, t₀, is the time stamp of the first data point in the Dynamic Testing data set with units of: time
Measured Response Process Variable, PV, with units specific to the Process Variable and/or its signal
Manipulated Variable, M, with units specific to the Manipulated Variable

### Model Fitting Using a Steady State Approximation

As is generally known, techniques for computing an Optimal Fit of a FOPDT Dynamic Model expressed in the time domain as shown in Equation 1 or a FOPDT Integrating Dynamic Model expressed in the time domain as shown in Equation 2 to Dynamic Testing Data are based upon the assumptions that:

1) The Dynamic Testing data begins with Steady State information that defines proper initial conditions PV(t=t₀) and M(t=t₀) as required when solving Equation 1 or Equation 2, or

2) That an average of the first data points in the data set provide a reasonable approximation of Steady State information that defines proper initial conditions PV(t=t₀) and M(t=t0) as required when solving Equation 1 or Equation 2, or

3) That ad hoc and/or heuristic mathematical analysis and assumptions can permit a numerical approximation of Steady State that defines proper initial conditions PV(t=t₀) and M(t=t₀) as required when solving Equation 1 or Equation 2.

The Optimal Fit of the Dynamic Models can then be expressed as a sequence of mathematical steps. For convenience in describing this sequence herein, the initial values in a Dynamic Testing data set are assigned here to have a time stamp of t=t₀, and the first data points is indicated as the initial condition values, PV(t=t₀) and M(t=t₀). This assignment of variables is provided to facilitate discussion and in no way limits the generality of the procedure.

The Optimal Fit of the Dynamic Models is then summarized by the following method or sequence:

1) Determine Steady State values from the Dynamic Testing data, either by directly assigning the first data point in the data set as Steady State values, by averaging the first few data points in the data set as a reasonable approximation of Steady State values, or by employing other mathematical analyses, methods and assumptions such that Steady State value can be determined and assigned as the proper initial conditions, PV(t=t₀) and M(t=t₀), as required for the solution of the FOPDT Dynamic Model of Equation 1 or the FOPDT Integrating Dynamic Model expressed in Equation 2.

2) Estimate values for Kp, Tp, and θp for the FOPDT time domain Dynamic Model of Equation 1, or Kp* and θp for the FOPDT Integrating time domain Dynamic Model of Equation 2.

3) Employ a numerical technique, such as for example the Runge-Kutta method (as described in, e.g., Press, W. H., S. Teukolsky, W. Vetterling, B. Flannery, “Numerical Recipes 3rd Edition: The Art of Scientific Computing,” Cambridge University Press; 3rd edition (2007), hereinafter “Press, et el., 2007”), to solve the time domain differential equation based upon the initial conditions PV(t=t₀) and M(t=t₀) as determined in Step 1, the coefficients estimated in Step 2, and the actual values recorded during Dynamic Testing for the Manipulated Variable, M(t), along with the actual recorded time stamp, t. This solution produces Dynamic Model predicted values for the measured response Process Variable, assigned the designation PV^{M}(t). The superscript “M” serves to differentiate these model-predicted values from the actual measured response Process Variable PV(t) values collected during Dynamic Testing.

4) Compute an Optimal Fit objective function criterion such as, for example, the sum of squared errors (SSE) criterion of Equation 3 below, where at each sample time presented is both an actual Dynamic Testing value PVᵢ and a Dynamic Model predicted value PVᵢ^{M} for a total of N data points collected during Dynamic Testing, computed as:

$$SSE = {\sum }_{i = 1}^{N} {[ {PV}_{i} - {PV}_{i}^{M} ]}^{2} \qquad ( 3 )$$

5) Use an optimization technique such as, for example, the Levenberg-Marquardt Algorithm (e.g., Press, et el., 2007), to perform a systematic search for the values of the model coefficients of Step 2 above that satisfy the Optimal Fit objective function criterion of Step 4 to a user-defined level of convergence.

6) Upon convergence, the resultant model coefficients cause the completed Dynamic Model to portray and describe the observed and/or actual relationship between a Manipulated Process Variable and a measured response Process Variable as contained in the Dynamic Testing data set.

As indicated above, the aforementioned conventional procedure uses Steady State information and/or Steady State approximations to define proper and appropriate values for the initial conditions of PV(t=t₀) and M(t=t₀). As should be appreciated, the accuracy and precision of these initial conditions directly impacts the resultant values of the model coefficients of Step 2 of the procedure, and thus impacts the ability of the Dynamic Model to accurately portray and describe the observed and/or actual relationship between a Manipulated Process Variable (M) and a measured response Process Variable (PV) as contained in the Dynamic Testing data set. Given the above described difficulties in obtaining and/or estimating Steady State, the accuracy of the conventional control methodologies is questionable.

In accordance with the present invention, a methodology and solution procedure is provide that does not require steady state values or approximations to serve as initial conditions PV(t=t₀) and M(t=t₀), yet still produces model coefficient values that cause the Dynamic Model to portray and describe the observed and/or actual relationship between a Manipulated Variable and a measured response Process Variable.

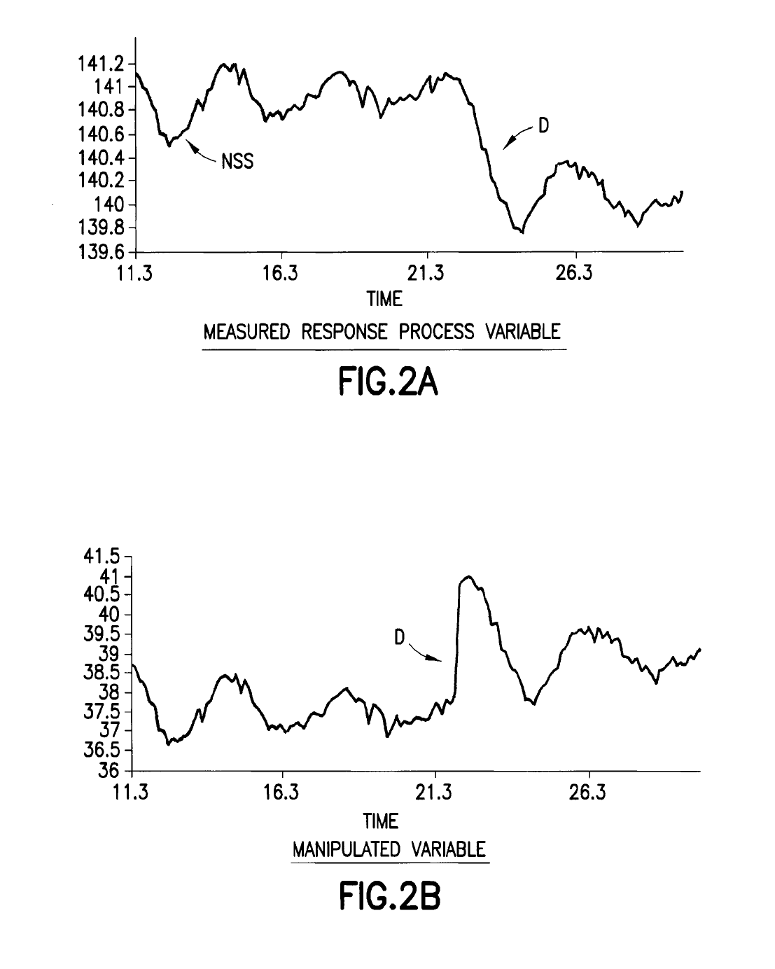

As shown in FIGS. 2A and 2B, the definition of Dynamic Testing remains the same in that it requires the deliberate or fortuitous change, movement or bump of a Manipulated Variable and/or its Signal, and concurrent collection and accumulation of pertinent Signals as the measured response Process Variable reacts over recorded time to that change. While the Manipulated Variable may change in any direction, may alternate direction, and may change randomly and without plan, at least one of the changes must be large enough and occur rapidly enough to cause a measurable and distinct reaction or effect in the responding Process Variable.

For example, as shown in FIG. 2A, a measured response Process Variable is not initially at steady state, but rather, is oscillating as shown generally at a point labeled NSS in FIG. 2A to a large extent relative to a dynamic event D that occurs at approximately time t=22. FIG. 2B illustrates the corresponding time-based trace of a Manipulated Variable (M). As indicated in FIG. 2B, the dynamic event D (at approximately t=22) forces a reaction in the measured response Process Variable in FIG. 2A. This provides the information required for Dynamic Modeling using techniques of the present invention as set forth herein.

The Optimal Fit of the Dynamic Models using Non Steady State data is summarized by the following method or sequence:

1) Assign a first data point in the Dynamic Testing data file (e.g., the N data points) as the proper initial condition, PV(t=t₀) and M(t=t₀), as required for the solution of the FOPDT Dynamic Model expressed in Equation 1 or the FOPDT Integrating Dynamic Model of Equation 2. These are assigned regardless of whether the first point of the data set reflects steady state or non-steady-state conditions, outlier values, or otherwise flawed or inappropriate initial conditions.

2) Compute an estimate of dead time θp using, for example, a cross-correlation between the Manipulated Variable M(t) and the measured response Process Variable PV(t) for an entire set of N data points. An exemplary set of N data points and resulting PV, M and Err values is depicted in Table 1 below. The cross-correlation is a measure of similarity of two waveforms, and the location in time of the first or initial peak value in the right hand plane of the cross-correlation waveform along the axis normally labeled as: time, delay, sample number, shift, lag or similar unit of measure. The cross-correlation provides an example means of determining an initial estimate for the model coefficient θp for the FOPDT time domain Dynamic Model of Equation 1 and/or the FOPDT Integrating time domain Dynamic Model of Equation 2.

3) Estimate a value for the time constant, Tp, for the FOPDT time domain Dynamic Model of Equation 1. Methods of estimating an initial value for Tp include, but are not limited to, assuming that Tp is a multiple of the time spacing that is used when collecting data during Dynamic Testing. Such a multiple may range in value from as small as the time that passes between any two samples to as large as the time that passes while collecting, for example, one hundred (100) or more samples. Other methods include assuming an initial value for Tp based on a fraction of the total time that passes between the start and completion of a Dynamic Testing event. Such a fraction may range from as small as perhaps one percent (1%) to as large as twenty-five (25%) of the total passage of time that occurred during Dynamic Testing.

4) With initial values for dead time θp and time constant Tp for the FOPDT time domain Dynamic Model of Equation 1; or dead time θp for the FOPDT Integrating time domain Dynamic Model of Equation 2; a Golden Section search may be used (e.g., as described in Press, et el., 2007) to obtain an initial estimate for process gain Kp of fitting Equation 1, or Kp* of fitting Equation 2.

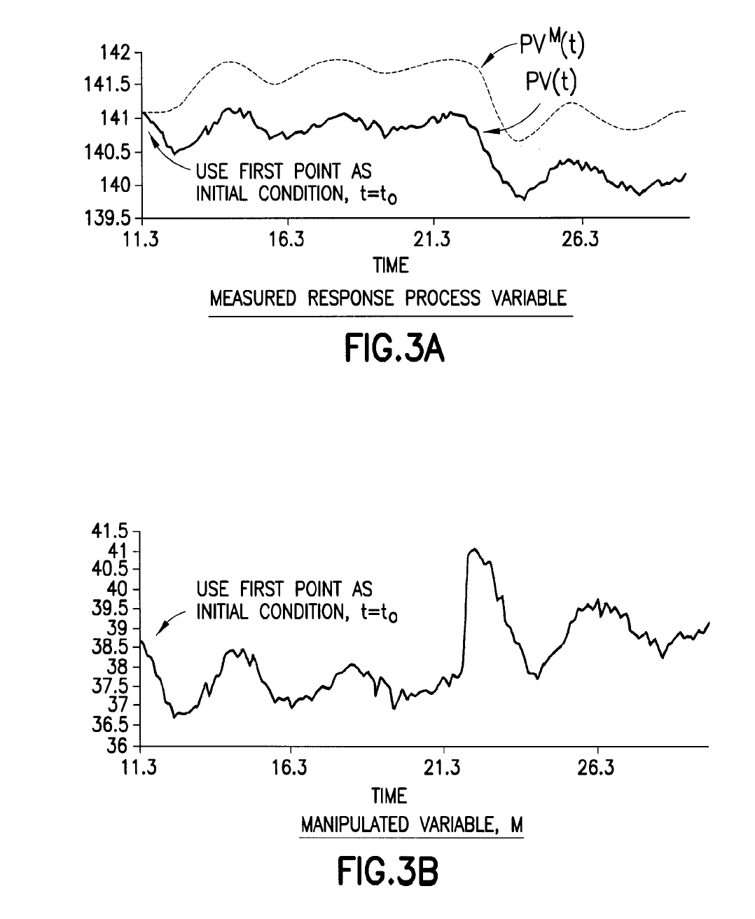

5) Employ a numerical technique, such as for example the Runge-Kutta method or other methods (e.g., as described in Press, et el., 2007) to solve the time domain differential equation based upon the initial conditions PV(t=t₀) and M(t=t₀) as determined in Step 1, the θp coefficient value computed in Step 2, the coefficients estimated in Steps 3 and 4, and the actual values recorded during Dynamic Testing for the Manipulated Variable, M(t), along with the actual recorded time stamp, t. As shown in FIGS. 3A and 3B, this solution produces non-steady-state Dynamic Model predicted values for the measured response Process Variable, assigned the designation PV^{M}(t). The superscript “M” serves to differentiate these model-predicted values from the actual PV(t) values collected during Dynamic Testing.

It should be appreciated that because no regard was given to determining or obtaining proper or appropriate steady state initial conditions, the PV^{M}(t) values may not track, overlay or reasonably approximate the measured response Process Variable PV(t) values collected during Dynamic Testing. As depicted in FIGS. 3A and 3B, the computed Dynamic Model PV^{M}(t) values may in fact diverge significantly from the measured response Process Variable PV(t) values collected during Dynamic Testing. For example, FIG. 3A shows the dynamic model PV^{M}(t) that is computed by using a numerical technique to solve the time domain differential equation when using the first point in the Dynamic Testing data file as the required initial conditions. As illustrated in FIG. 3A, this solution produces Dynamic Model predicted values for the measured response Process Variable, assigned the designation PV^{M}(t). The superscript “M” serves to differentiate these model-predicted values from the actual PV(t) values collected during Dynamic Testing. FIG. 3B depicts the corresponding Manipulated Variable M(t) values of the sample period.

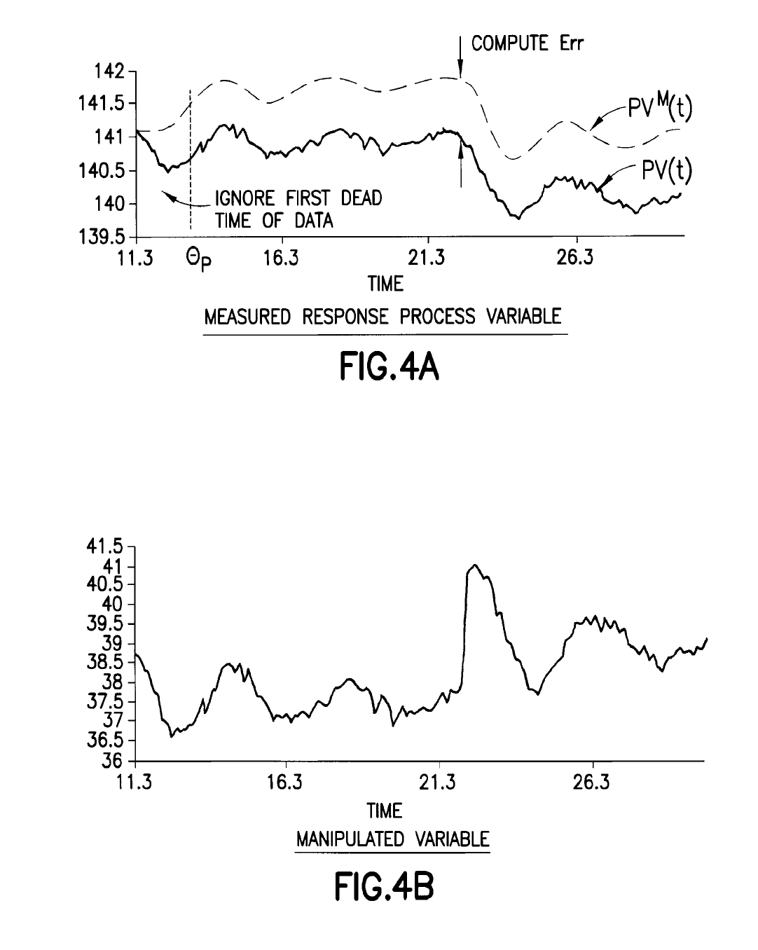

6) As illustrated in FIGS. 4A and 4B, computation starts at a point in time beginning one dead time θp along the data file and computes the average error, assigned the symbol Err in Equation 4 below, between the Dynamic Model computed PV^{M}(t) values and the measured response Process Variable PV(t) values, where at each sample time there is both an actual Dynamic Testing value PVᵢ and a Dynamic Model predicted value PVᵢ^{M} for the total of all data values, N, collected during Dynamic Testing, computed as:

$$Err = \frac{{\sum }_{i = {θ}_{p}}^{N} [ {PV}_{i} - {PV}_{i}^{M} ]}{N - {θ}_{p}} \qquad ( 4 )$$

FIG. 4A illustrates graphically the computation of Err as defined in Equation 4. For example, starting at the point in time beginning one dead time θp along the data file, the average error Err is computed between the computed PV^{M}(t) values and the measured response PV(t) values, for N-θp data values, where N is the total number of samples collected during Dynamic Testing. FIG. 4B depicts the corresponding Manipulated Variable M(t) values of the sample period. Table 1 includes Err values computed for the N data points described herein.

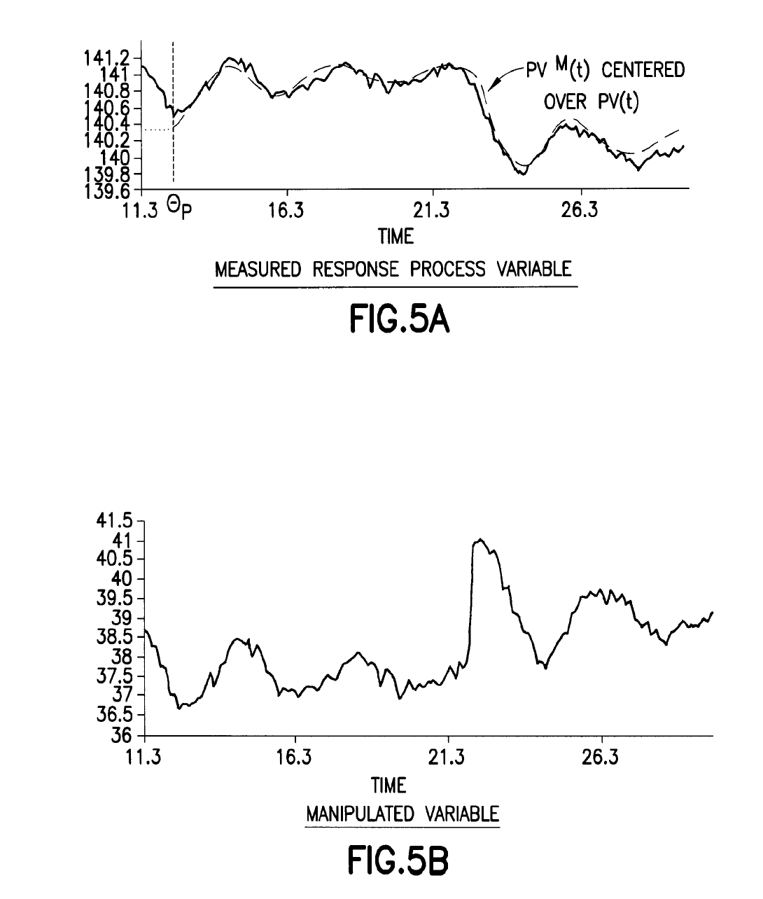

7) As shown in FIGS. 5A and 5B, the Dynamic Model predicted values are centered by adding the value of Err, defined in Equation 4, to every Dynamic Model predicted data point, PV^{M}(t), in the entire data set of N samples. Accordingly, the PV^{M}(t) values are shifted and centered over the measured response Process Variable values, PV(t), collected during Dynamic Testing. FIG. 5B depicts the corresponding Manipulated Variable M(t) values of the sample period. Table 1 also includes the Centered Model data values computed for the N data points described herein.

8) Computation continues by computing an Optimal Fit objective function criterion on the shifted and centered data relative to the measured response Process Variable PV(t) values collected during Dynamic Testing. That portion of the data and model that occurs prior to the passage of dead time θp is not considered in forming this Optimal Fit objective function. For every iteration prior to convergence, the value of θp, and thus the number of data points employed in the calculation, can change. Thus, an objective function that is normalized to eliminate the influence of the reduced set of data points such as, for example, the square of the correlation coefficient (R2), is employed.

9) Using optimization techniques, including but not limited to the Levenberg-Marquardt algorithm and other methods (e.g., Press, et el., 2007), perform a systematic search for the coefficient values Kp, Tp, and θp for the FOPDT time domain Dynamic Model of Equation 1, or Kp* and θp for the FOPDT Integrating time domain Dynamic Model of Equation 2, that satisfy the Optimal Fit objective function criterion as defined in Step 8. Subsequent iterations in this optimization produce new Dynamic Model coefficient values. In one embodiment, the inventive technique returns to Step 5 for each new set of coefficient values and follows the subsequent steps detailed above as a component of the optimization procedure.

10) Upon reaching a user-defined level of convergence, the resultant model coefficients cause the completed Dynamic Model to portray and describe the observed and/or actual relationship between a Manipulated Process Variable and a measured response Process Variable as contained in the Dynamic Testing data set.

TABLE 1
N Data Points.

| | Process | Model | Manipulated | | Centered |
|---|---|---|---|---|---|
| Time | Variable (PV) | Fit | Variable (M) | Err | Model |
| 11.267 | 141.1 | 141.1 | 38.71 | 0 | 140.3275 |
| 11.417 | 141.093 | 141.1 | 38.578 | 0.007 | 140.3275 |
| 11.567 | 140.997 | 141.1 | 38.297 | 0.103 | 140.3275 |
| 11.717 | 140.951 | 141.1 | 38.158 | 0.149 | 140.3275 |
| 11.867 | 140.831 | 141.1 | 37.785 | 0.269 | 140.3275 |
| 12.017 | 140.787 | 141.1 | 37.628 | 0.313 | 140.3275 |
| 12.167 | 140.596 | 141.103 | 37.019 | 0.507 | 140.3305 |
| 12.317 | 140.594 | 141.115 | 36.969 | 0.521 | 140.3425 |
| 12.467 | 140.497 | 141.141 | 36.625 | 0.644 | 140.3685 |
| 12.617 | 140.559 | 141.18 | 36.757 | 0.621 | 140.4075 |
| 12.767 | 140.573 | 141.233 | 36.749 | 0.66 | 140.4605 |
| 12.917 | 140.601 | 141.302 | 36.786 | 0.701 | 140.5295 |
| 13.067 | 140.646 | 141.387 | 36.883 | 0.741 | 140.6145 |
| 13.217 | 140.681 | 141.48 | 36.954 | 0.799 | 140.7075 |
| 13.367 | 140.782 | 141.571 | 37.226 | 0.789 | 140.7985 |
| 13.517 | 140.897 | 141.652 | 37.552 | 0.755 | 140.8795 |
| 13.667 | 140.808 | 141.719 | 37.268 | 0.911 | 140.9465 |
| 13.817 | 140.964 | 141.775 | 37.728 | 0.811 | 141.0025 |
| 13.967 | 140.995 | 141.818 | 37.817 | 0.823 | 141.0455 |
| 14.117 | 141.13 | 141.846 | 38.231 | 0.716 | 141.0735 |
| 14.267 | 141.181 | 141.853 | 38.392 | 0.672 | 141.0805 |
| 14.417 | 141.184 | 141.849 | 38.415 | 0.665 | 141.0765 |
| 14.567 | 141.132 | 141.841 | 38.274 | 0.709 | 141.0685 |
| 14.717 | 141.185 | 141.82 | 38.446 | 0.635 | 141.0475 |
| 14.867 | 141.045 | 141.784 | 38.034 | 0.739 | 141.0115 |
| 15.017 | 141.132 | 141.733 | 38.301 | 0.601 | 140.9605 |
| 15.167 | 141.019 | 141.676 | 37.964 | 0.657 | 140.9035 |
| 15.317 | 140.905 | 141.625 | 37.619 | 0.72 | 140.8525 |
| 15.467 | 140.861 | 141.583 | 37.478 | 0.722 | 140.8105 |
| 15.617 | 140.831 | 141.55 | 37.372 | 0.719 | 140.7775 |
| 15.767 | 140.719 | 141.528 | 37.014 | 0.809 | 140.7555 |
| 15.917 | 140.776 | 141.512 | 37.158 | 0.736 | 140.7395 |
| 16.067 | 140.766 | 141.514 | 37.101 | 0.748 | 140.7415 |
| 16.217 | 140.787 | 141.535 | 37.14 | 0.748 | 140.7625 |
| 16.367 | 140.729 | 141.566 | 36.939 | 0.837 | 140.7935 |
| 16.517 | 140.794 | 141.607 | 37.113 | 0.813 | 140.8345 |
| 16.667 | 140.822 | 141.653 | 37.176 | 0.831 | 140.8805 |
| 16.817 | 140.842 | 141.696 | 37.218 | 0.854 | 140.9235 |
| 16.967 | 140.806 | 141.731 | 37.092 | 0.925 | 140.9585 |
| 17.117 | 140.882 | 141.766 | 37.303 | 0.884 | 140.9935 |
| 17.267 | 140.941 | 141.799 | 37.473 | 0.858 | 141.0265 |
| 17.417 | 140.926 | 141.824 | 37.421 | 0.898 | 141.0515 |
| 17.567 | 140.917 | 141.84 | 37.393 | 0.923 | 141.0675 |
| 17.717 | 141.03 | 141.853 | 37.729 | 0.823 | 141.0805 |
| 17.867 | 141.064 | 141.865 | 37.839 | 0.801 | 141.0925 |
| 18.017 | 141.086 | 141.869 | 37.909 | 0.783 | 141.0965 |
| 18.167 | 141.122 | 141.867 | 38.024 | 0.745 | 141.0945 |
| 18.317 | 141.129 | 141.859 | 38.055 | 0.73 | 141.0865 |
| 18.467 | 141.079 | 141.852 | 37.918 | 0.773 | 141.0795 |
| 18.617 | 141.021 | 141.842 | 37.753 | 0.821 | 141.0695 |
| 18.767 | 141.054 | 141.819 | 37.855 | 0.765 | 141.0465 |
| 18.917 | 140.997 | 141.788 | 37.684 | 0.791 | 141.0155 |
| 19.067 | 140.849 | 141.755 | 37.236 | 0.906 | 140.9825 |
| 19.217 | 141.002 | 141.72 | 37.685 | 0.718 | 140.9475 |
| 19.367 | 140.969 | 141.69 | 37.579 | 0.721 | 140.9175 |
| 19.517 | 140.907 | 141.671 | 37.383 | 0.764 | 140.8985 |
| 19.667 | 140.748 | 141.66 | 36.89 | 0.912 | 140.8875 |
| 19.817 | 140.807 | 141.654 | 37.051 | 0.847 | 140.8815 |
| 19.967 | 140.91 | 141.661 | 37.346 | 0.751 | 140.8885 |
| 20.117 | 140.854 | 141.677 | 37.158 | 0.823 | 140.9045 |
| 20.267 | 140.895 | 141.685 | 37.267 | 0.79 | 140.9125 |
| 20.417 | 140.878 | 141.692 | 37.205 | 0.814 | 140.9195 |
| 20.567 | 140.914 | 141.716 | 37.3 | 0.802 | 140.9435 |
| 20.717 | 140.934 | 141.755 | 37.351 | 0.821 | 140.9825 |
| 20.867 | 140.911 | 141.785 | 37.275 | 0.874 | 141.0125 |
| 21.017 | 140.922 | 141.802 | 37.305 | 0.88 | 141.0295 |
| 21.167 | 141.019 | 141.816 | 37.595 | 0.797 | 141.0435 |
| 21.317 | 141.06 | 141.829 | 37.722 | 0.769 | 141.0565 |
| 21.467 | 140.977 | 141.839 | 37.473 | 0.862 | 141.0665 |
| 21.617 | 141.08 | 141.844 | 37.79 | 0.764 | 141.0715 |
| 21.767 | 141.06 | 141.847 | 37.738 | 0.787 | 141.0745 |
| 21.917 | 141.114 | 141.851 | 37.909 | 0.737 | 141.0785 |
| 22.067 | 141.076 | 141.848 | 40.839 | 0.772 | 141.0755 |
| 22.217 | 141.069 | 141.833 | 40.94 | 0.764 | 141.0605 |
| 22.367 | 141.054 | 141.815 | 41.012 | 0.761 | 141.0425 |
| 22.517 | 140.981 | 141.801 | 40.909 | 0.82 | 141.0285 |
| 22.667 | 140.874 | 141.781 | 40.694 | 0.907 | 141.0085 |
| 22.817 | 140.851 | 141.758 | 40.728 | 0.907 | 140.9855 |
| 22.967 | 140.702 | 141.675 | 40.361 | 0.973 | 140.9025 |
| 23.117 | 140.48 | 141.494 | 39.766 | 1.014 | 140.7215 |
| 23.267 | 140.469 | 141.284 | 39.791 | 0.815 | 140.5115 |
| 23.417 | 140.242 | 141.099 | 39.149 | 0.857 | 140.3265 |
| 23.567 | 140.176 | 140.945 | 38.973 | 0.769 | 140.1725 |
| 23.717 | 140.058 | 140.82 | 38.627 | 0.762 | 140.0475 |
| 23.867 | 140.025 | 140.72 | 38.527 | 0.695 | 139.9475 |
| 24.017 | 139.942 | 140.657 | 38.266 | 0.715 | 139.8845 |
| 24.167 | 139.812 | 140.63 | 37.858 | 0.818 | 139.8575 |
| 24.317 | 139.809 | 140.626 | 37.826 | 0.817 | 139.8535 |
| 24.467 | 139.775 | 140.65 | 37.703 | 0.875 | 139.8775 |
| 24.617 | 139.886 | 140.693 | 38.019 | 0.807 | 139.9205 |
| 24.767 | 139.944 | 140.748 | 38.184 | 0.804 | 139.9755 |
| 24.917 | 139.996 | 140.81 | 38.341 | 0.814 | 140.0375 |
| 25.067 | 140.061 | 140.883 | 38.541 | 0.822 | 140.1105 |
| 25.217 | 140.088 | 140.966 | 38.635 | 0.878 | 140.1935 |
| 25.367 | 140.236 | 141.049 | 39.103 | 0.813 | 140.2765 |
| 25.517 | 140.26 | 141.119 | 39.202 | 0.859 | 140.3465 |
| 25.667 | 140.357 | 141.167 | 39.529 | 0.81 | 140.3945 |
| 25.817 | 140.348 | 141.196 | 39.538 | 0.848 | 140.4235 |
| 25.967 | 140.373 | 141.208 | 39.654 | 0.835 | 140.4355 |
| 26.117 | 140.324 | 141.208 | 39.548 | 0.884 | 140.4355 |
| 26.267 | 140.364 | 141.191 | 39.705 | 0.827 | 140.4185 |
| 26.417 | 140.232 | 141.157 | 39.344 | 0.925 | 140.3845 |
| 26.567 | 140.331 | 141.11 | 39.677 | 0.779 | 140.3375 |
| 26.717 | 140.233 | 141.055 | 39.414 | 0.822 | 140.2825 |
| 26.867 | 140.278 | 141 | 39.58 | 0.722 | 140.2275 |
| 27.017 | 140.181 | 140.949 | 39.312 | 0.768 | 140.1765 |
| 27.167 | 140.201 | 140.904 | 39.394 | 0.703 | 140.1315 |
| 27.317 | 140.061 | 140.869 | 38.987 | 0.808 | 140.0965 |
| 27.467 | 140.02 | 140.841 | 38.872 | 0.821 | 140.0685 |
| 27.617 | 139.978 | 140.816 | 38.746 | 0.838 | 140.0435 |
| 27.767 | 140.028 | 140.795 | 38.892 | 0.767 | 140.0225 |
| 27.917 | 139.923 | 140.781 | 38.571 | 0.858 | 140.0085 |
| 28.067 | 139.97 | 140.773 | 38.707 | 0.803 | 140.0005 |
| 28.217 | 139.879 | 140.776 | 38.422 | 0.897 | 140.0035 |
| 28.367 | 139.84 | 140.794 | 38.294 | 0.954 | 140.0215 |
| 28.517 | 139.936 | 140.823 | 38.575 | 0.887 | 140.0505 |
| 28.667 | 139.971 | 140.851 | 38.673 | 0.88 | 140.0785 |
| 28.817 | 140.003 | 140.879 | 38.763 | 0.876 | 140.1065 |
| 28.967 | 140.054 | 140.91 | 38.916 | 0.856 | 140.1375 |
| 29.117 | 139.998 | 140.943 | 38.749 | 0.945 | 140.1705 |
| 29.267 | 140.01 | 140.981 | 38.791 | 0.971 | 140.2085 |
| 29.417 | 140.004 | 141.019 | 38.775 | 1.015 | 140.2465 |
| 29.567 | 140.077 | 141.042 | 39.001 | 0.965 | 140.2695 |
| 29.717 | 140.043 | 141.052 | 38.908 | 1.009 | 140.2795 |
| 29.867 | 140.119 | 141.053 | 39.15 | 0.934 | 140.2805 |
| | | | Err Avg | 0.772472 | |

It should be appreciated that while in the aforementioned sequence, procedure or method it is stated that the dead time θp is estimated and the associated data that is computed and/or recorded prior to that point in time is eliminated from the computational procedures, in another embodiment, the data computed or recorded prior to dead time θp is considered. It should also be appreciated that it is within the scope of the present invention to optionally employ a weighted filter after one dead time θp of data to, for example, gradually increase (positively weighted filter) or decrease (negatively weighted filter) the importance of data after one dead time, e.g. time t>θp. As noted above, the use of the weighted filter is an enhancement to the aforementioned sequence, procedure or method. Moreover, while the inventive methodology is presented in a general nature, it should be recognized that implementation (e.g., in hardware circuits or software programming routines) is simplified if the Dynamic Testing data and Dynamic Model are normalized in advance such that t₀=0, and that initial condition becomes PV(0)=0 with coupled initial condition of M(0)=0.

As described herein, the Non-Steady-State (NSS) Model Fitting sequence, procedure or method performs Model Fitting to determine coefficients of a Dynamic Model such that the resultant continuous, time-dependent differential equation provides an Optimal Fit description of the Dynamics contained in a set of Process data generated by Dynamic Testing. At least one perceived novel capability of the NSS Modeling Fitting methods described herein is that the methodology applies a unique approach to the Model Fitting of Dynamic Models by eliminating the need for reaching Steady State operation prior to the start of Dynamic Testing of a given Process. Further, actions of the Manipulated Variable during Dynamic Testing can be completely free of form, requiring no restrictions to specific shapes such as steps, pulses, or similar limitations.

Some features and advantages of the NSS Model Fitting methodology as described herein include, for example:
precision tuning of PID (proportional, integral, derivative) controllers;
modeling process behavior from Plant data;
monitoring and analysis of controller performance;
designing advanced control strategies;
creating customized control loop simulations;
performing “what if” studies and new strategy investigations;
Open Process Control (OPC) client & short-term historian;
training and skills enhancement;

Accordingly, the NSS Model Fitting methodology enables process operators, technicians and engineers to decrease production cost, reduce waste and minimize the environmental impact of Plants. At the same time, optimization of Plant operation and improved performance of business-critical processes helps maintain Plant safety, improve product quality and increase total Plant throughput, which have significant cost benefits.

It should be understood that the present invention is not limited with regard to the metaphor utilized to realize an email or document reduction program. Accordingly, although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method of modeling a process using non-steady state values of a process variable implemented in a control unit, the method comprising steps of:
dynamically testing the process and accumulating data points over a predetermined time period, the data points providing a dynamic testing data set including measured values of a response process variable and a manipulated variable;
assigning a first data point within the dynamic testing data set;
computing a dead time value for the dynamic testing data set;
dynamically modeling the process over the dynamic testing data set to determine model-predicted values for the measured response process variable;
beginning at a data point within the dynamic testing data set that is one dead time within the dynamic testing data set, computing an average error value between each of the dynamic model-predicted values and the measured response process variable values;
centering and shifting the dynamic model-predicted values over the measured response process variable values;
computing an optimal fit of the centered and shifted dynamic model-predicted values relative to the measured response process variable values; and
iteratively executing the dynamic modeling, computing average error, centering and shifting, and computing the optimal fit steps until the dynamic model-predicted values converge to the measured response process variable values within a predetermined level of convergence.

2. The method of claim 1, wherein the measured values of the response process variable and the manipulated variable are accumulated by measuring by a sensor operatively coupled to the control unit.

3. The method of claim 1, wherein the step of computing the dead time value includes determining a cross-correlation between the manipulated variable values and the measured response process variable values over the dynamic testing data set.

4. The method of claim 1, wherein the step of dynamically modeling includes solving a continuous-in-time form of a first-order-plus-dead-time (FOPDT) self-regulating dynamic model.

5. The method of claim 4, wherein the FOPDT self-regulating dynamic model is expressed as:
$$Tp \frac{d PV ( t )}{d t} + PV ( t ) = Kp \cdot M ( t - θ p )$$
with initial condition of PV(t=t₀) and initial condition of M(t=t₀), and
where:
Kp is model process gain with units of: PV/M;
Tp is a model time constant with units of time;
θp is the model dead time with units of time;
t is time with units of time;
t₀ is a time stamp of a first data point in the dynamic testing data set with units of time;
PV is the measured response process variable with units specific to the process variable; and
M is the manipulated variable with units specific to the manipulated variable.

6. The method of claim 5, wherein an initial value of the model time constant Tp is estimated assuming that Tp is a multiple of time spacing when accumulating data points during the step of dynamically testing the process.

7. The method of claim 5, wherein an initial value of the model time constant Tp is estimated assuming that Tp is based on a fraction if a total time that passes between a start of and a completion of the step of dynamically testing the process.

8. The method of claim 5, wherein the step of dynamically modeling further includes solving the FOPDT self-regulating dynamic model expression using a numerical technique and with initial values of the model dead time θp and the model time constant Tp, and estimates of the model process gain Kp determined using a Golden Section search.

9. The method of claim 1, wherein the step of dynamically modeling includes solving a continuous-in-time form of a first-order-plus-dead-time integrating (FOPDT integrating) non-self-regulating dynamic model.

10. The method of claim 9, wherein the FOPDT integrating non-self-regulating dynamic model is expressed as:
$$\frac{d PV ( t )}{d t} = {Kp}^{*} \cdot M ( t - θ p )$$
with initial condition of PV(t=t₀) and coupled initial condition of M(t=t₀), and
where:
Kp* is integrator process gain with units of: PV/(M·time);
θp is the model dead time with units of time;
t is time with units of time;
t₀ is a time stamp of a first data point in the dynamic testing data set with units of time;
PV is the measured response process variable with units specific to the process variable; and
M is the manipulated variable with units specific to the manipulated variable.

11. The method of claim 10, wherein the step of dynamically modeling further includes solving the FOPDT integrating non-self-regulating dynamic model expression using a numerical technique and with initial values of the model dead time θp, and estimates of the integrator process gain Kp* determined using a Golden Section search.

12. The method of claim 1, wherein the average error is expressed as:
$$Err = \frac{{\sum }_{i = {θ}_{p}}^{N} [ {PV}_{i} - {PV}_{i}^{M} ]}{N - {θ}_{p}}$$
where:
N is a total number of the accumulating data points;
θp is the model dead time with units of time;
PV is the measured response process variable with units specific to the process variable; and
PV^{M} is the model-predicted value for the measured response process variable.

13. The method of claim 1, wherein the step of centering and shifting includes adding the average error value to each of the dynamic model-predicted values within the dynamic testing data set.

14. The method of claim 1, wherein the step of computing the optimal fit includes employing a square of the correlation coefficient function.

15. The method of claim 1, wherein the step of computing the optimal fit further includes using optimization techniques to perform a search for coefficient values of the dynamically modeling step.

16. The method of claim 15, wherein the optimization technique includes employing a Levenberg-Marquardt algorithm.

17. The method of claim 1, wherein the method further includes optionally employing a weighted filter to the data points within the dynamic testing data set for at least one of gradually increasing or gradually decreasing an importance of data points.

18. The method of claim 1, wherein the method further includes normalizing the data points within the dynamic testing data set.

19. A method of modeling a process using non-steady state values of a process variable implemented in a control unit, the method comprising steps of:
dynamically testing the process and accumulating data points over a predetermined time period, the data points providing a dynamic testing data set including measured values of a response process variable and a manipulated variable;
assigning a first data point within the dynamic testing data set;
computing a dead time value for the dynamic testing data set;
dynamically modeling the process over the dynamic testing data set to determine model-predicted values for the measured response process variable;
computing an average error value between each of the dynamic model-predicted values and the measured response process variable values;
centering and shifting the dynamic model-predicted values over the measured response process variable values;
computing an optimal fit of the centered and shifted dynamic model-predicted values relative to the measured response process variable values; and
iteratively executing the dynamic modeling, computing average error, centering and shifting, and computing the optimal fit steps until the dynamic model-predicted values converge to the measured response process variable values within a predetermined level of convergence.

20. The method of claim 19, wherein the measured values of the response process variable and the manipulated variable are accumulated by measuring by a sensor operatively coupled to the control unit.
